(19) United States
(12) Patent Application Publication
(10) Pub. No.: US 2024/0192127 A1
(43) Pub. Date: Jun. 13, 2024

(54) OPTICAL MEASURING SYSTEM

(71) Applicant: Endress+Hauser Conducta GmbH+Co. KG, Gerlingen (DE)

(72) Inventors: Joachim Bolle, Stockach (DE); Andreas Bayer, Gerlingen (DE); Thilo Krätschmer, Gerlingen (DE)

(21) Appl. No.: 18/530,760

(22) Filed: Dec. 6, 2023

(30) Foreign Application Priority Data
Dec. 9, 2022 (DE) 10 2022 132 802.3

(51) Int. Cl. G01N 21/25; G01N 21/27

(52) U.S. Cl. CPC G01N 21/255; G01N 21/27; G01N 2201/0634; G01N 2201/0666

(57) ABSTRACT

An optical measuring system for determining a measured variable in a medium includes a light source and a container with medium. The light source radiates measuring light into the container on a first light path, wherein the measuring light is converted into reception light as a function of the measured variable and radiates reference light past the container on a second light path. A diffusion disk is arranged between the container and a receiver, wherein the diffusion disk is configured and arranged such that the reception light impinges on the receiver through the diffusion disk. The diffusion disk is configured such that the reference light impinges on the receiver through the diffusion disk. The receiver receives the reception light and the reference light, and a data processing unit connected to the light source and to the receiver determines the measured variable from the measuring light and the reception light.

### CROSS-REFERENCE TO RELATED APPLICATION

The present application is related to and claims the priority benefit of German Patent Application No. 10 2022 132 802.3, filed on Dec. 9, 2022, the entire contents of which are incorporated herein by reference.

### TECHNICAL FIELD

The present disclosure relates to an optical measuring system for determining a measured variable in a medium.

### BACKGROUND

When optically determining a measured variable, light is radiated as measuring light into the medium to be examined. This light is changed by the medium and received as reception light by a receiver. The ratio of irradiated light to received light is a measure of the measured variable.

It is advantageous if, apart from the measuring beam (transmission light), a reference beam is additionally guided past the medium and onto the receiver. The analysis of the reference beam provides information about the temporal aging of, or other changes to, the light source the light source, thereby preventing errors due to aging of the light source.

A disadvantage here is that the superimposition of the measuring beam and reference beam before the receiver is technically complex under the boundary condition of optimal illumination of the numerical aperture of the receiver. When using a reference beam, the optimal coupling of the measuring beam and reference beam into the receiver is a challenge. For coupling, a beam splitter can be used in the vicinity of the receiver, for example, wherein the numerical aperture of the receiver has to be fully illuminated in the best case. For this purpose, the two light fields must be brought to a common axis, which requires an exact adjustment and is therefore technically complex.

### SUMMARY

The object of the present disclosure is to simplify the reference path of an optical measuring system.

The object is achieved by an optical measuring system for determining a measured variable in a medium, comprising a light source for emitting light; a container with medium, wherein the light source radiates measuring light into the container with medium on a first light path, wherein the measuring light is converted by the medium into reception light as a function of the measured variable and radiates reference light past the container with medium on a second light path; a diffusion disk arranged between the container with medium and a receiver, wherein the diffusion disk is configured and arranged such that the reception light, after exiting the container with medium, impinges on the receiver through the diffusion disk, wherein the diffusion disk is configured and arranged such that the reference light impinges on the receiver through the diffusion disk; the receiver which receives the reception light and the reference light; and a data processing unit connected to the light source and to the receiver which determines the measured variable from the measuring light and the reception light.

In general, diffusion disks are optical and lighting components and serve for uniform scattering of the incident light without changing the spectral characteristics of the incident radiation. Objects in optical beam paths can thus be illuminated and imaged uniformly.

One embodiment provides for the diffusion disk to be configured as a volume diffusion disk; the volume diffusion disk is made, in particular, of opal glass, quartz glass or frosted flashed glass.

Volume diffusion disks consist, for example, of opal glass or frosted flashed glass. The light-scattering effect of the volume diffusion disks is brought about by the different refractive indices of insoluble glass components or crystallites in the glass matrix. The surface of the base glass is not roughened by grinding or sandblasting, but coated with a milky white opal layer to produce an extremely uniform and diffuse light. Opal glass can be used to obtain an almost Lambertian emitter. It is true that the high degree of diffusion in opal glass provides for loss due to forward and backward scattering, but one also gets an extremely homogeneous shadow-poor illumination. Volume diffusion disks scatter the light very uniformly and homogeneously within a wide spectral range.

In one embodiment, one volume diffusion disk is made of quartz glass. The quartz glass comprises many, for example millions, of small gas bubbles in synthetic quartz glass. They act as optical scattering centers. These gas bubbles have a diameter of approximately 4 μm and are distributed uniformly in the quartz glass volume. Due to this functional principle, neither surface defects nor superficial contaminations have an effect on the scattering behavior.

One embodiment provides for the diffusion disk to be configured as a surface diffusion disk.

The light-scattering effect in surface diffusion disks is brought about by the microscopically fine irregularities on the glass surface. As a result of the individual irregularities at each point of the glass surface, the light is deflected in different directions by diffraction, refraction and reflection. The glass surface can be roughened mechanically by grinding or sandblasting, and chemically by etching by means of hydrofluoric acid or phosphates. The rougher the surface, the greater the light-scattering effect.

One embodiment provides for the diffusion disk to be configured as a converging lens.

One embodiment provides for the reception light and the reference light to form an overlap surface on the diffusion disk.

One embodiment provides for the measuring system to comprise a light selector which switches light from the light source between the first light path and the second light path as measuring light or reference light.

One embodiment provides for the receiver to be configured as a spectrometer.

One embodiment provides for the measuring system to comprise an optical waveguide, wherein the light source couples reference light on the second light path into the optical waveguide, the optical waveguide runs past the container with medium, and couples reference light from the optical waveguide onto the diffusion disk.

One embodiment provides for the measuring system to comprise one or more mirrors, wherein the light source guides reference light on the second light path via the at least one mirror past the container with medium and onto the diffusion disk.

### BRIEF DESCRIPTION OF THE DRAWINGS

This is explained in more detail with reference to the following figures.

FIG. 1 shows the claimed measuring system.

FIG. 2 shows a detail of the claimed measuring system.

FIG. 3 shows the claimed measuring system in one embodiment.

In the figures, the same features are labeled with the same reference signs.

### DETAILED DESCRIPTION

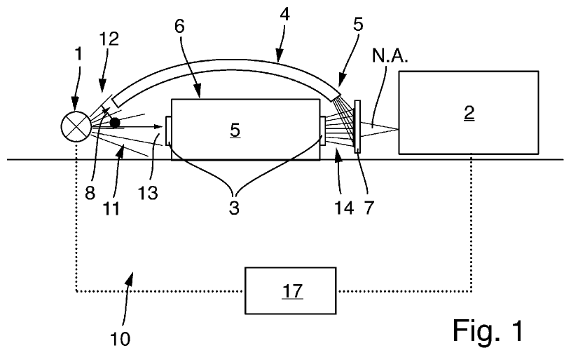

The claimed measuring system in its entirety is denoted by reference sign 10 and is shown in FIG. 1.

The optical measuring system 10 comprises at least one light source 1 for transmitting light. The light source 1 is a broadband light source and configured, for example, as a Xenon flash lamp. Alternatively, an array of LEDs is used, for example. A possible wavelength range comprises the range of 200-1000 nm. The system 10 comprises a receiver 2. The receiver 2 is also referred to as detector. The medium to be measured has reference symbol 5. It is located in a container 6, e.g., a cuvette, between the light source 1 and the detector 2. The detector 2 is configured as a spectrometer, so that the spectrum of the light falling onto the detector 2 can be represented, for example in a connected measuring transducer (not shown). The container 6 has transparent windows 3 for the transmitted light at the inlet and outlet.

Spectrometric measurements are a meaningful method for analyzing liquids and gases in the industrial sector. In absorption spectroscopy, as mentioned, a broadband light source is used, the light of which is guided through the medium to be examined and subsequently analyzed in a spectrometer. The substances and mixtures of substances present in the medium may be identified by means of their characteristic absorption lines. Depending on the atomic and molecular spectrum, different wavelengths are of interest. It is important here that here not only the desire of identifying individual lines is relevant, but also their absolute signal strength, since information about the respective concentration can be calculated therefrom. In particular, many substances that are of practical significance for industrial applications have absorption lines in the ultraviolet spectral range. A UV spectrometer for analyzing such a substance mixture thus requires, in particular, a photodetector designed for the wavelength range and an associated, suitable light source.

The light source 1 transmits measuring light 13 to the container 6 with medium 5 on a first light path 11, wherein the measuring light 13 is converted by the medium 5 into reception light 14 as a function of the measured variable. The system 10 comprises a data processing unit 17 which is connected to the light source 1 and the receiver 2 and determines the measured variable from the reception light 14 and the reference light 15. The reference light 15 is transmitted from the light source 1 past the medium 5.

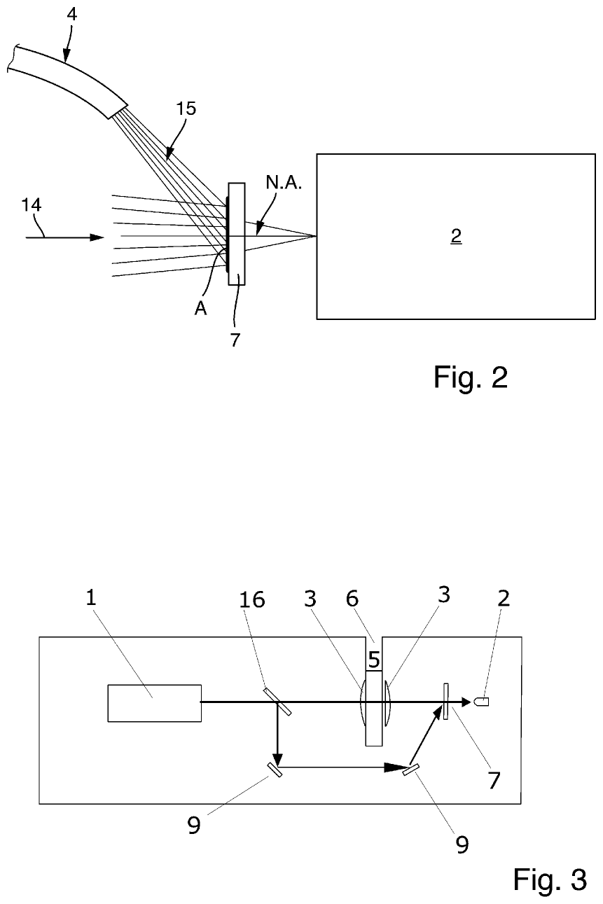

The light source 1 thus transmits the reference light 15 past the container 6 with medium 5 on a second light path 12. For this purpose, two embodiments are to be shown, the first one in FIG. 1 with a detail in FIG. 2; FIG. 3 shows the second embodiment.

In the embodiment in FIGS. 1 and 2, reference light 15 of light source 1 is coupled into an optical waveguide 4 in the region of the light source 1. The optical waveguide 4 is guided past the container.

In the embodiment in FIG. 3, the reference light 15 is guided around the container 6 as a free beam. For this purpose, the measuring system 10 comprises one or more mirrors 9.

A light selector 8 for switching between the first 11 and second 12 light paths can be used. FIG. 1 symbolically indicates the light selector 8. The light selector 8 is, for example, a moving diaphragm, so that either measuring light 13 or reference light 15 is blocked. The actual beam path remains unchanged by the light selector 8. In one embodiment, the light selector 8 is configured as an optical switch. Alternatively, a beam splitter 16 (see FIG. 3) can be used. A shutter may be possibly necessary.

When using a reference beam, coupling of the measuring light and reference light into the spectrometer 2 is important. For coupling, a beam splitter can be used on this side as well, wherein in the optimal case the numerical aperture N.A. of the spectrometer 2 must be fully illuminated. For this purpose, the two light fields must be brought to a common axis, which requires an exact adjustment and is therefore technically complex.

When using a diffusion disk 7, which is arranged between the container 6 with medium 5 and the receiver 2, this adjustment effort can be omitted if only the disk is suitably illuminated by the measuring and reference light 13, 15.

The diffusion disk 7 is configured and arranged such that the reception light 14 impinges on the receiver 2 through the diffusion disk 7 after exiting the container 6. The diffusion disk 7 is configured and arranged such that the reference light 15 impinges on the receiver 2 through the diffusion disk 7. See FIGS. 1 and 2 in this regard.

After having exited the container 6 at window 3, the reception light 14 impinges on the diffusion disk 7. The diffusion disk 7 is arranged, for example, directly behind the container 6 so that reception light 14 impinges substantially perpendicularly on the disk 7. The optical waveguide 4 is guided around the container and the optical waveguide 4 is directed in the direction of the disk 7. The reference light 15 does not impinge perpendicularly on the disk 7, but at an angle >0° to the normal to the circle plane, for example 45°.

The diffusion disk 7 is configured as a converging lens, for example.

The diffusion disk 7 is configured, for example, as a volume diffusion disks; the volume diffusion disk is in particular manufactured from opal glass, quartz glass or frosted flashed glass.

The diffusion disk 7 can also be configured as a surface diffusion disk.

The reference light 15 is guided with the optical light guide 4 or as a free beam (with, for example, mirrors 9; lenses or other optical deflection elements can also be used as an alternative to the imaged mirrors) around the medium 5, is roughly aligned and directed onto the diffusion disk 7. The diffusion disk 7 then ensures optimum coupling into the spectrometer 2, without an exact adjustment of the output of the light guide 4 or of the beam guiding element 9, when guided around the medium as a free beam.

The output of the light guide 4 must only be aligned roughly with the diffusion disk 7 so that an overlap A between measuring light and reference light 13, 15 is produced on the diffusion disk 7.

The diffusion disk 7 ensures that both measuring light and reference light 13, 15 optimally illuminate the numerical aperture N.A. of the spectrometer 2.

This leads to an adjustment-free coupling of a reference beam 15 analogous to the measuring beam 13 into the spectrometer with the aid of a diffusion disk 7.

The analysis of the reference beam provides information about the temporal aging of, or other changes to, the light source 1, thereby preventing erroneous measurement results due to aging of the light source 1.

1. An optical measuring system for determining a measured variable in a medium, comprising
a light source for emitting light;
a container with medium, wherein the light source:
radiates measuring light into the container with medium on a first light path, wherein the measuring light is converted by the medium into reception light as a function of the measured variable; and
radiates reference light past the container with medium on a second light path;
a diffusion disk arranged between the container with medium and a receiver;
wherein the diffusion disk is configured and arranged such that the reception light impinges on the receiver through the diffusion disk after exiting the container with medium;
wherein the diffusion disk is configured and arranged such that the reference light impinges on the receiver through the diffusion disk;
the receiver that receives the reception light and the reference light; and
a data processing unit which is connected to the light source and the receiver and determines the measured variable from the reception light and the reference light.

2. The measuring system according to claim 1,
wherein the diffusion disk is configured as a volume diffusion disk; the volume diffusion disk is in particular manufactured from opal glass, quartz glass or frosted flashed glass.

3. The measuring system according to claim 1,
wherein the diffusion disk is configured as a surface diffusion disk.

4. The measuring system according to claim 1,
wherein the diffusion disk is configured as a converging lens.

5. The measuring system according to claim 1,
wherein the reception light and the reference light form an overlap surface on the diffusion disk.

6. The measuring system according to claim 1, comprising
a light selector which switches light from the light source between the first light path and the second light path as measuring light or reference light.

7. The measuring system according to claim 1,
wherein the receiver is configured as a spectrometer.

8. The measuring system according to claim 1, comprising
an optical waveguide,
wherein the light source couples reference light on the second light path into the optical waveguide, the optical waveguide runs past the container with medium, and couples reference light from the optical waveguide onto the diffusion disk.

9. The measuring system according to claim 1, comprising
one or more mirrors;
wherein the light source guides reference light on the second light path via the at least one mirror past the container with medium and onto the diffusion disk.
